(19) United States
(12) Patent Application Publication
(10) Pub. No.: US 2024/0007979 A1
(43) Pub. Date: Jan. 4, 2024

(54) TIMING ADVANCE CALCULATION AND PRACH SCHEDULING FOR HAPS SWITCHING

(71) Applicant: Nokia Technologies Oy, Espoo (FI)

(72) Inventors: Ryan Keating, Chicago, IL (US); Tzu-Chung Hsieh, Hoffman Estate, IL (US); Jeroen Wigard, Klarup (DE); Rafhael Medeiros de Amorim, Aalborg (DK)

(21) Appl. No.: 18/248,416

(22) PCT Filed: Oct. 15, 2020
(86) PCT No.: PCT/US20/55696

§ 371 Date: Apr. 10, 2023

(51) Int. Cl. H04W 56/00; H04B 7/185

(52) U.S. Cl. CPC H04W 56/0045; H04B 7/18504

(57) ABSTRACT

Methods and apparatus, including computer program products, are provided for switching between platforms. In some example embodiment, there may be provided a method, which may include receiving, by a user equipment, a notification indicative of a switch from a first platform to a second platform; calculating, by the user equipment, a timing advance for use with the second platform; and accessing, by the user equipment, the second platform after the switch to the second platform, the accessing based on at least the calculated timing advance. Related systems, methods, and articles of manufacture are also disclosed.

### FIELD

The subject matter described herein relates to wireless communications.

### BACKGROUND

The phrase “High Altitude Platform Station” or “HAPS” refers to a telecommunication infrastructure solution based on airborne platforms including platforms in the stratosphere. For example, HAPS may operate at altitudes between about 20 kilometers (km) to about 50 km to provide coverage for a service area up to about 1,000 km diameter (and about 800,000 square kilometers) depending on a minimum elevation angle accepted from the user equipment's location. The HAPS may be based on an airborne platform, such as a balloon, a solar powered high-altitude plane, a drone, and/or other types of airborne platforms. For example, Loon is an operating balloon providing cellular LTE coverage over Peru or Puerto Rico.

### SUMMARY

In some example embodiment, there may be provided a method, which may include receiving, by a user equipment, a notification indicative of a switch from a first platform to a second platform; calculating, by the user equipment, a timing advance for use with the second platform; and accessing, by the user equipment, the second platform after the switch to the second platform, the accessing based on at least the calculated timing advance.

In some variations, one or more of the features disclosed herein including the following features can optionally be included in any feasible combination. The first platform may include one or more of the following: an airborne platform, a spaceborne platform, and a high altitude platform station. The second platform may include one or more of the following: an airborne platform, a spaceborne platform, and a high altitude platform station. At least a portion of a first base station may include, or be included in, the first platform. At least a portion of a second base station may include, or be included in, the second platform. The first base station may be terrestrial and may access, via a first repeater link, the first platform. The second base station may be terrestrial and may access, via a second repeater link, the second platform. The user equipment may receive location information, wherein the location information includes a first location of the first platform and a second location of the second platform. In response to received notification and/or the received location information, a location of the user equipment may be determined. The location of the user equipment may be determined based on at least geolocation circuitry at the user equipment. The timing advanced may be calculated based on at least the location of the user equipment and at least one of the first location of the first platform and the second location of the second platform. A resource allocation may be received, wherein the resource allocation is for the user equipment accessing a physical random access control channel after the switch to the second platform, wherein the accessing, by the user equipment, of the second platform is further based on at least the received resource allocation. After the switch, the second platform may use a different physical cell identifier than the first platform. A switching time may be received, wherein the accessing the second platform is further based on at least the received switching time. After the switch, the second platform may use a same physical cell identifier as the first platform, and wherein the switching time comprises a subframe number, and/or wherein the switching time is received from the first platform. The user equipment may receive information about the second platform, wherein the received information includes the physical cell identifier, a synchronization signal block timing index, and/or a synchronization signal block measurement timing configuration time shift, wherein the timing advance calculation is further based on a synchronization signal block timing difference between the second platform and the first platform. The user equipment may receive an indication of an addition or a deletion of an inter-platform link between the first platform and the second platform, wherein the timing advance calculation is further based on a change in delay associated with the addition or the deletion.

In some example embodiment, there may be provided a method, which may include serving, by a first platform, at least a user equipment; and broadcasting, by the first platform, a notification to the user equipment, the notification indicative of a switch from the first platform to a second platform to enable the user equipment to access the second platform after the switch.

In some variations, one or more of the features disclosed herein including the following features can optionally be included in any feasible combination. The first platform may include one or more of the following: an airborne platform, a spaceborne platform, and a high altitude platform station, and/or wherein the second platform comprises one or more of the following: an airborne platform, a spaceborne platform, and a high altitude platform station. At least a portion of a first base station may include, or be included in, the first platform. At least a portion of a second base station may include, or be included in, the second platform. The first base station may be terrestrial and may access, via a first repeater link, the first platform. The second base station may be terrestrial and may access, via a second repeater link, the second platform. Location information may be sent to the user equipment, wherein the location information includes a first location of the first platform and a second location of the second platform. A resource allocation may be sent to the user equipment, wherein the resource allocation enables the user equipment to access a physical random access control channel after the switch to the second platform. After the switch, the second platform may use a different physical cell identifier than the first platform. A switching time may be sent to the user equipment, wherein the switching time enables the user equipment to access the second platform. After the switch, the second platform may use a same physical cell identifier as the first platform, and wherein the switching time comprises a subframe number. The user equipment may receive information about the second platform, wherein the received information includes the physical cell identifier, a synchronization signal block timing index, and/or a synchronization signal block measurement timing configuration time shift, wherein the timing advance calculation is further based on a synchronization signal block timing difference between the second platform and the first platform. An indication may be sent to the user equipment, wherein the indication indicates an addition or a deletion of an inter-platform link between the first platform and the second platform.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example of a HAPS system, in accordance with some example embodiments;

FIG. 2 depicts an example of a user equipment being switched from a first HAPS to a second HAPS, in accordance with some example embodiments;

FIG. 3 depicts an example of a process for switching between two HAPs when the PCI changes during the HAPS switch, in accordance with some example embodiments;

FIG. 4 depicts an example of a process for switching between two HAPs when the PCI stays the same during the HAPS switch, in accordance with some example embodiments;

FIG. 5 depicts another example of a process for switching between two HAPs when the PCI changes during the HAPS switch, in accordance with some example embodiments;

FIG. 6 depicts another example of a process for switching between two HAPs when the PCI stays the same during the HAPS switch, in accordance with some example embodiments;

FIG. 7 depicts an example of an inter-HAPS link addition or deletion, in accordance with some example embodiments;

FIG. 8 depicts an example of a network node, in accordance with some example embodiments; and

FIG. 9 depicts an example of an apparatus, in accordance with some example embodiments.

Like labels are used to refer to same or similar items in the drawings.

### DETAILED DESCRIPTION

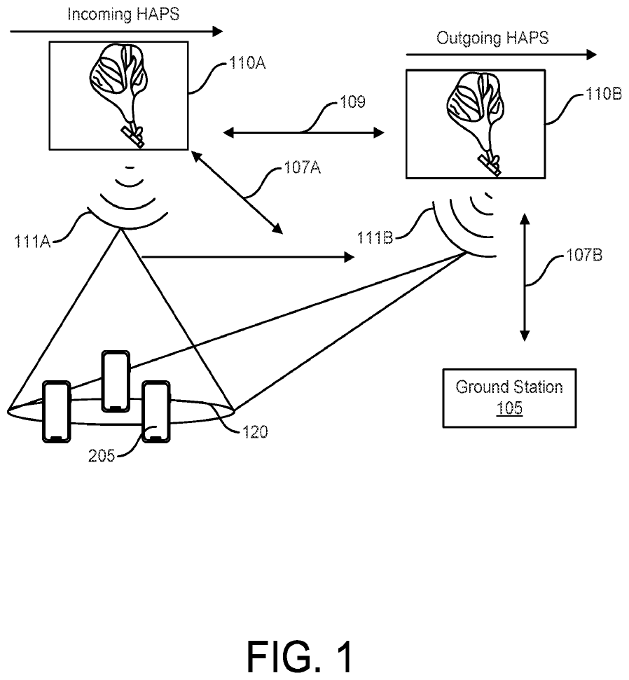

FIG. 1 depicts an example of a HAPS system deployment covering a particular geographical area 120, in accordance with some example embodiments. In the example of FIG. 1, the system includes a first HAPS 110A and a second HAPS 110B each of which provides a radio access network, or cell, 120 over a coverage area on the surface of the Earth. The radio access network or cell 120 may serve a plurality of user equipment. The HAPS 110A-B are depicted as deployed, at least in part, by balloons, although other types of airborne vehicles may be used as well. Each of the HAPS may include at least a portion of a base station, such as a gNB type base station or other type of cellular base station, to provide the radio access network or cell in a geographic area. To illustrate further, the first HAPS 110A may include a complete base station, such as a gNB, although the first HAPS may include a subset of that base station as well (e.g., one or more antennas for transmission and/or reception and at least a portion of the RF transceiver(s)). To illustrate further, a first base station may be located at least in part at the first HAPS 110. An illustrative example of this includes the first base station being located at least in part terrestrially (e.g., at a ground station or other location) and using, via a feeder link, at least one or more antennas at the first HAPS to serve the user equipment in cell 120.

In the example of FIG. 1, the HAPS 110A-B are moving (which is in contrast to fixed, terrestrial base station). This movement may not be a predictable, repeatable motion as is the case with a LEO or GEO satellite platforms. For example, a HAPS, such as the balloon type HAPS, may move non-deterministically in the stratosphere. As such, for a certain geographical area to have constant coverage, the area may need to be served by a plurality of different HAPS at different times. In the example of FIG. 1, the HAPS 110B may be considered an outgoing HAPS, which is currently serving the area 120 but due to motion incoming HAPS 110A may be better able to serve area 120. Due to its altitude, the coverage area for a HAPS may be a much larger area, when compared to a terrestrial base station.

The HAPS may include service links 111A-B, such as a service uplink and/or a service downlink, between the HAPS and the user equipment. There may also be feeder links 107A-B, such as a feeder uplink and/or a feeder downlink, between the HAPS and a ground station 105 for the HAPS. The feeder link may be used to connect the HAPS to the core network (e.g., a 5G core network) and/or to connect to some of the other components of the HAPS' base station (as a subset or portion of the HAPS base station may be positioned terrestrially). In some instances, an inter-HAPS link 109 may be used between the HAPS 110A-B. This inter-HAPS link may be used for a variety of reasons including providing HAPS 110B access to the ground station 105 via the inter-HAPS link 108 (although HAPS 110B may configure its own feeder link to the ground station as well).

A cell (which is being served by a HAPS) may be identified with a physical cell identifier (PCI). In HAPS including those which share spectrum with terrestrial networks, it may be advantageous to minimize the number of PCIs that are required solely for use by the HAPS.

As noted, there is a need for a plurality of HAPS to cover a given geographic area on the Earth's surface such as area 120 due to, for example, movement of the HAPS over time. This may necessitate a switching between HAPS, which may be handled by the network, such as a base station or other node in the network. This switching between HAPS may occur due to the HAPS drifting out of range of the coverage area 120 and/or a break down in the feeder uplink or feeder downlink. When a switch from a first HAPS to a second HAPS occurs, the user equipment may see a sudden change in the value of the timing advance (TA). The TA represents a value that corresponds to a length of time a signal takes to reach the user equipment from the HAPS base station.

Although some of the examples refer to a portion of the base station being located on the platform, such as the HAPS, the base station may be located wholly on the ground and access the HAPS for transmission or reception. For example, a full base station may be positioned terrestrially and access, via an uplink relay, one or more antennas at the HAPS to enable transmission via the antennas and/or reception via the antennas (which may also be provided via a downlink relay) to the base station. The relay links may serves as transparent relays between the base station and the HAPS. In this context, the HAPS may be viewed as an extension, via the relay, of the terrestrial base station.

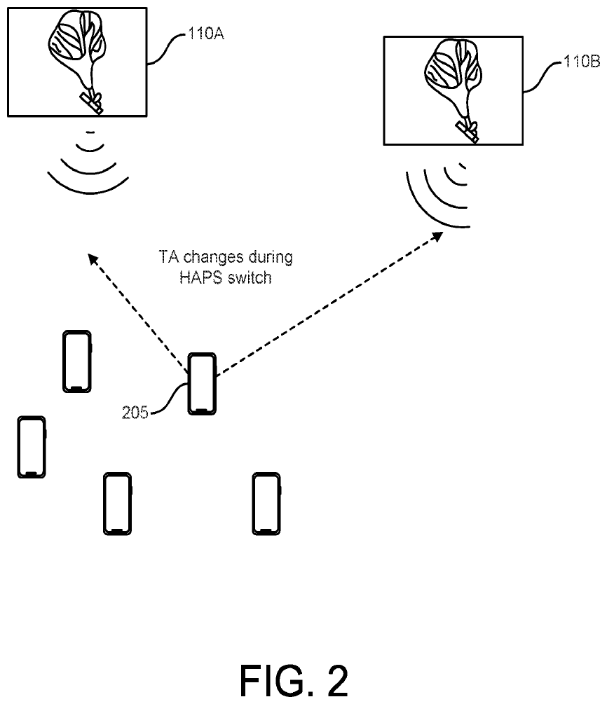

FIG. 2 depicts an example of a user equipment 205 being switched from a first HAPS 110B to a second HAPS 110A, in accordance with some example embodiments. The switching between the first and second HAPS 110A-B may be implemented using a physical cell identity (PCI) change, such that the first outgoing HAPS 110B and the second, incoming HAPS 110A are identified by different PCIs. Alternatively, the switching between the first and second HAPS 110A-B may be implemented using the same physical cell identity (PCI), so that the first, outgoing HAPS and the second, incoming HAPS are identified by the same PCI.

In the case of different PCIs, the switching between the HAPS may represent a full handover of the user equipment from the HAPS 110B (e.g., the base station associated with HAPS 110B) to HAPS 110A (e.g., the base station associated with HAPS 110A). The handover may, however, present some challenges due to, for example, the TA change and due to a plurality of UEs needing to transmit a connection request on the Physical Random Access Control Channel (PRACH) towards the second, incoming HAPS 110A, within a relatively short window of time. The large quantity of user equipment transmitting on the PRACH at the same time may likely cause interference, a high quantity of retransmissions, and/or delays.

In the case of the same PCI being used during the HAPS switch, the user equipment may not experience a full handover but the user equipment may still need to change the TA in order to communicate with the second, incoming HAPS 110A. If nothing is done to change the TA, the user equipment may experience radio link failure (RLF), when a switch is performed from the first outgoing HAPS 110B to the second, incoming HAPS 110A.

Moreover, if an inter-HAPS link is used between HAPS 110A-B to facilitate use of the feeder link, there may be additional changes in time delay and Doppler experienced by the UEs.

In some example embodiments, there is provided a way to switch between HAPS, each of which may include at least a portion of a cellular base station, such a gNB base station, on board the HAPS platform.

In some example embodiments, there is provided a scheme for timing advance (TA) calculation and PRACH scheduling after the HAPS switching.

In some example embodiments, when a switch is expected from a first HAPS to a second HAPS, the first HAPS (which is the outgoing or source HAPS) may notify the user equipment being served of a HAPS switch. The first HAPS may also broadcast its location and the location of the second HAPS (which is the incoming or target HAPS). This broadcast may include an indication (e.g., a bit) of whether the PCI of the incoming, second HAPS changes after the switch to the incoming HAPS or remains the same after the switch to the incoming HAPS.

In some example embodiments, the user equipment may trigger a determination of its location (e.g., a Global Navigation Satellite System (GNSS) positioning fix) when a notification of a HAPS switch is received. The user equipment may only need to determine its GNSS location, when the HAPS switch is about to happen. Alternatively, the user equipment may get a location estimate via other mechanisms (e.g., from the cellular network).

In some example embodiments, the user equipment may calculate the TA based on the location of the outgoing HAPS, the location of the incoming HAPS, and the location of the user equipment.

When the PCI changes during the HAPS switch, the outgoing HAPS may provide to the user equipment a reserved resource for a dedicated PRACH.

When the PCI stays the same during the HAPS switch, the user equipment may receive a switching time (e.g., subframe number) from which to start using the new TA.

In some example embodiments, the outgoing HAPS may trigger the switch to the incoming HAPS. In the case of the PCI changing during the HAPS switch, the user equipment may transmit on the PRACH (using the TA calculated by the user equipment, for example) to complete the switch to the incoming HAPS, although a 2-step RACH may optionally also be used. In the case of the PCI staying the same during the HAPS switch, the user equipment may start using the calculated TA to communicate with the new, incoming HAPS (without a PRACH transmission) at the configured switching time, such as the subframe number.

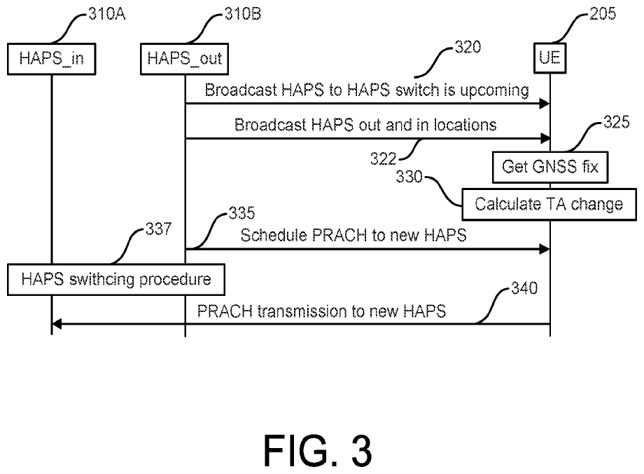

FIG. 3 depicts an example of a process for switching between two HAPs 310A-B, when the PCI changes during the HAPS switch, in accordance with some example embodiments. In the example of FIG. 3, the HAPS 310B is the source or outgoing HAPS and HAPS 310A is the target or incoming HAPS, so the switching is from the outgoing HAPS 310B to the incoming HAPS 310A. FIG. 3 also depicts at least one user equipment, such as the UE 205 being served.

At 320, the outgoing HAPS 310B may broadcast to the UEs including the UE 205 (which are being served) a notification that a HAPS switch is about to occur. At 322, the outgoing HAPS 310B may broadcast to the UEs (which may include the UE 205) location information, in accordance with some example embodiments. This location information may include the location of the outgoing HAPS 310B and the location of the incoming HAPS 310A. The location information enables the user equipment to calculate the timing advance (TA). The broadcast at 322 may be part of the same or a separate broadcast as 320. The broadcast at 320 or 322 may include indication (e.g., a bit) of whether the PCI of the incoming HAPS changes after the switch or remains the same after the switch to the second HAPS.

At 325, the user equipment 205 may determine its location, in accordance with some example embodiments. For example, the user equipment 205 may trigger a fix on its location in response to the notifications received at 320 and/or received location information at 322. The user equipment may determine its location as a GNSS location fix using the user equipment's GNSS circuitry, for example, although the user equipment's location may be determined based on other sources of location, such as cellular network provided location information.

At 330, the user equipment 205 may calculate a timing advance (TA) based on the UE's location (determined at 325) and based on the location information indicating the location of the HAPS 310A and the location of the HAPS 310B (which is received at 322). For example, the user equipment may calculate the TA from the latencies (e.g., delays in time) between the user equipment and the source and target HAPS. To illustrate further, the difference between (1) a first latency value between the UE and the outgoing, source HAPS and (2) a second latency value between the UE and the incoming, target HAPS may indicate the change in TA.

At 335, the outgoing HAPS 310B may schedule for the user equipment 205 the PRACH to the incoming HAPs 310A. This scheduling enables the user equipment 205 to complete the switch by sending to the incoming HAPS 310A a connection request on the PRACH at the scheduled time. For example, the schedule may be in the form of a radio resource in time and/or frequency.

At 337, the switch from the source HAPS 310B to the target HAPS 310A may occur. When this occurs, the user equipment 205 completes the switch by sending, at 340, to the incoming HAPS 310A a connection request on the PRACH at the scheduled time or resource provided by the outgoing HAPS 310B at 335.

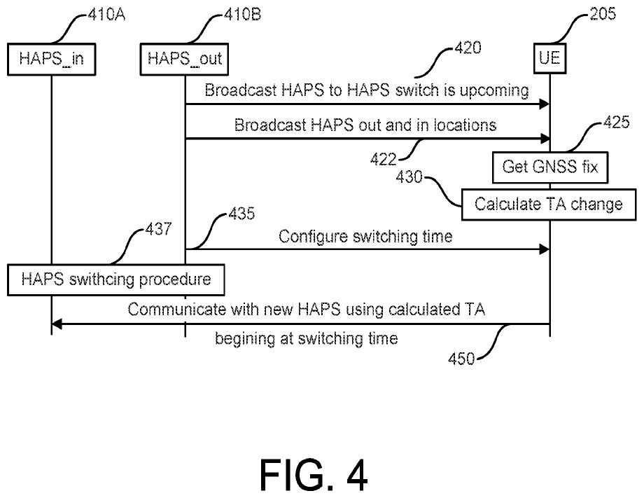

FIG. 4 depicts an example of a process for switching between two HAPs 410A-B when the PCI stays the same during the HAPS switch, in accordance with some example embodiments. In the example of FIG. 4, HAPs 410B is the outgoing HAPS and HAPS 410A is the incoming HAPS, so the switching is from the outgoing HAPS 410B to the incoming HAPS 410A.

At 420, the outgoing HAPS 410B may broadcast to the UEs including the UE 205 (which are being served) a notification that a HAPS switch is about to occur. At 422, the outgoing HAPS 310B may broadcast to the UEs (which may include the UE 205) location information, in accordance with some example embodiments. 420 and 422 may be implemented in a same or similar manner as described above with respect to 320 and 322. The broadcast at 420 or 422 may include indication (e.g., a bit) of whether the PCI of the incoming HAPS changes after the switch or remains the same after the switch to the second HAPS.

At 425, the UE 205 may determine its location, in accordance with some example embodiments. The location may be determined in a manner similar to or the same as 325 above.

At 430, the UE 205 may calculate a TA based on the UE's location (which is determined at 425) and the locations of each of the HAPS 410A-B (which is received at 422). The TA calculation may be similar to or the same as noted at 330 above.

At 435, the outgoing HAPS 410B provides to the UE 205 a switching time, such as a subframe number, to start using the calculated TA from. At 437, the switch from the outgoing HAPS 410B to the incoming HAPS 410A occurs. When this occurs, the user equipment 205 completes the switch by communicating, at 450, with the incoming HAPS 410A using the calculated TA (determined at 430) beginning at the configured switch time, such as the subframe number (which is provided at 435).

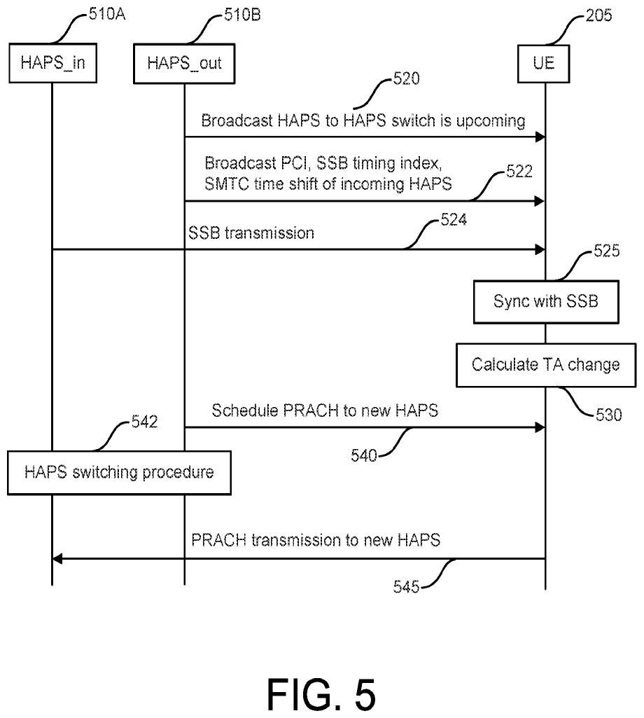

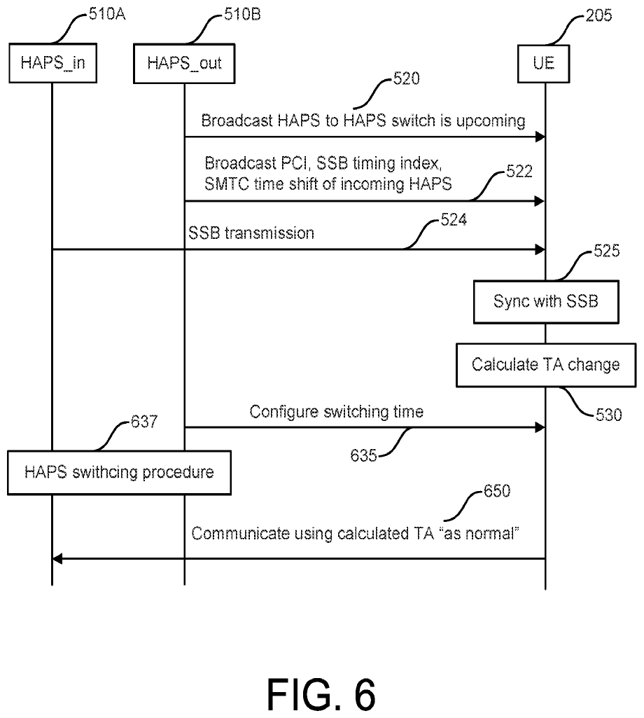

FIGS. 3 and 4 represent processes which may rely on a user equipment being able to determine its location using, for example, GNSS circuitry at the user equipment or some other geolocation technology. However, some user equipment, such as IoT devices, may not have this geolocation circuitry. As such, FIGS. 5 and 6 depict examples of processes that can be used with a wider variety of user equipment including those user equipment which may not be able to determine its geolocation using for example GNSS circuitry.

FIG. 5 depicts another example of a process for switching between two HAPs 510A-B when the PCI changes during the HAPS switch, in accordance with some example embodiments.

At 520, the outgoing HAPS 510B may broadcast to the UEs including the UE 205 (which are being served) a notification that a HAPS switch is about to occur. The outgoing HAPS 510B may also broadcast, at 522, to the UEs including the UE 205 information about the incoming HAPS 510A. This information about the incoming HAPS 510A may include the PCI of the incoming HAPS 510A, a synchronization signal block (SSB) timing index of the incoming HAPS 510A, and the SSB Measurement Timing Configuration (SMTC) time shift of the incoming HAPS 510A. The SMTC time shift reflects the propagation time difference between the outgoing HAPs 510B and the incoming HAPS 510A to a cell center and/or the change of delay in the inter-HAPS link. This SMTC time shift may be calculated from the location information for each of the HAPS 510A-B, the cell center location, and the gateway positions (in case of transparent HAPS). The configured SMTC duration should cover the timing difference variation within a cell, such as the cell covering area 120. The broadcast at 520 or 522 may include indication (e.g., a bit) of whether the PCI of the incoming HAPS changes after the switch or remains the same after the switch to the second HAPS.

The UE 205 may apply the SMTC time shift, and the UE may then acquire synchronization, at 525, from the SSB transmission 524 from the incoming HAPS 510A, using the indicated PCI and SSB timing index. The UE 205 may calculate a sync timing difference between the SSB from the incoming HAPS 510A and the outgoing HAPS 510B observed by the UE 205. For example, the sync timing difference (A t) may be determined as follows:

Δt=tᵢₙ−tₒᵤₜ

wherein tᵢₙ is the timing reference of the incoming HAPS 510A and tₒᵤₜ the timing reference of the outgoing HAPS 510B.

At 530, the user equipment 205 may calculate the TA for the incoming HAPS 510A (TAᵢₙ) in accordance with the following:

TAᵢₙ=TAₒᵤₜ+2Δt

wherein TAᵢₙ and TAₒᵤₜ denote the TA for the incoming and outgoing HAPS respectively.

At 540, the outgoing HAPS 510B may schedule (e.g., provide an indication of resource allocated in time and/or frequency) for the user equipment 205 the PRACH to the incoming HAPs 510A. 540 may be performed in the same or similar manner as described above with respect to 335.

At 542, the switch from the source HAPS 510B to the target HAPS 510A may occur. 542 may be performed in the same or similar manner as described above with respect to 337.

When the switch occurs at 543, the user equipment 205 completes the switch by sending, at 545, to the incoming HAPS 510A a connection request on the PRACH at the resource or scheduled time provided by the outgoing HAPS 310B. 545 may be performed in the same or similar manner as described above with respect to 340.

FIG. 6 depicts another example of a process for switching between two HAPs 510A-B when the PCI stays the same during the HAPS switch, in accordance with some example embodiments.

FIG. 6 is similar to FIG. 5 in some respects but covers operation using the same PCI after the HAPS switch, in accordance with some example embodiments. At 635, the outgoing HAPS 510B provides to the UE 205 a switching time, such as a subframe number, to start using the calculated TA from. At 637, the switch from the outgoing HAPS 510B to the incoming HAPS 510A occurs. When this occurs, the user equipment 205 completes the switch by communicating, at 650, with the incoming HAPS 510A using the calculated TA beginning at the configured switch time, such as the subframe number provided at 635.

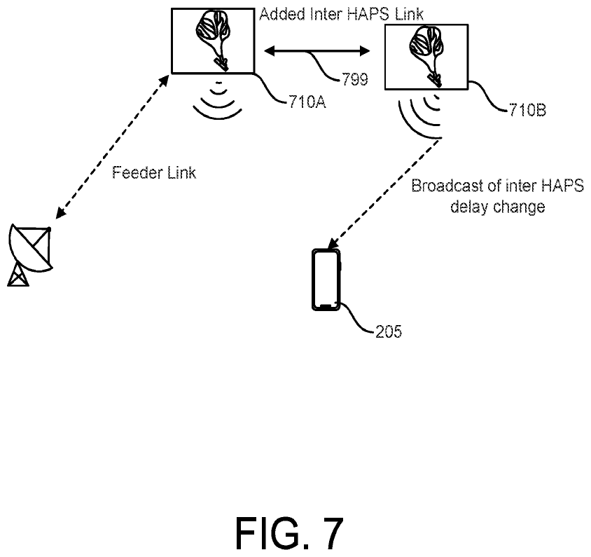

FIG. 7 depicts an example of an inter-HAPS link 799 addition or deletion, in accordance with some example embodiments.

In the case that an inter HAPS link 799 is added or dropped (or expected to be added/dropped) between a first HAPS 710A and a second HAPS 710B, the information about the added or dropped inter HAPS link 799 may also be broadcast by the HAPS to the user equipment 205. This broadcast information may inform the user equipment 205 of the change in time delay directly due to the inter HAPS link 799 addition or elimination. Instead of broadcasting that a HAPS switch is upcoming, the change in delay is just broadcast to the UEs and used immediately by the UEs including UE 205 or the delay may be sent with a starting time (e.g., a subframe number) where the change in delay occurs (and thus can be applied). If the addition or deletion of the link 799 is between the UE and the HAPS currently serving the UE, the addition or deletion of the link 799 (e.g., the time delay associated with link 799) may affect the TA value (e.g., an increase or decrease in the TA due to the addition or deletion, respectively).

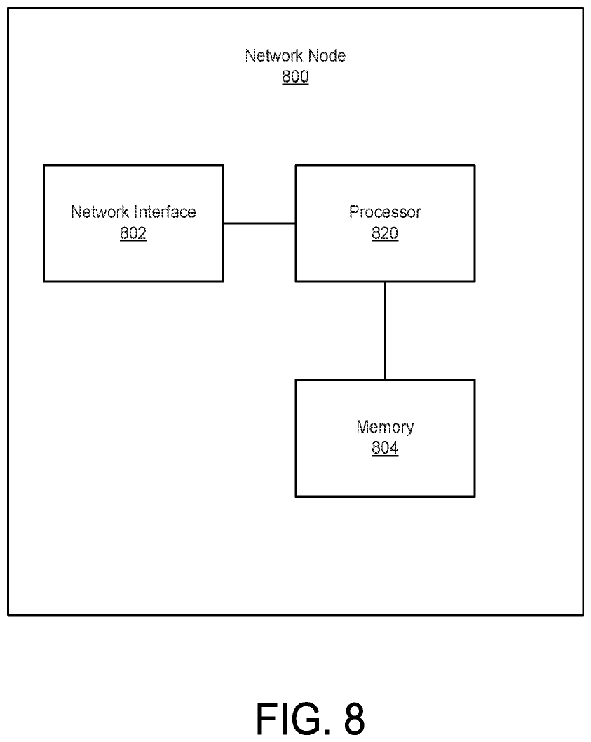

FIG. 8 depicts a block diagram of a network node 800, in accordance with some example embodiments. The network node 800 may be configured to provide one or more network side functions, such as a base station (e.g., gNB) located wholly, or in part, in a HAPS. As noted, in some embodiments, the base station may be located on the ground and access via one or more relays (e., uplinks and/or downlinks to the HAPS) at least one or more antennas on the HAPS to enable transmission and/or reception to the UEs in the coverage area. In some embodiments, the network node may be configured to serve at least a user equipment; and/or broadcast a notification to the user equipment, the notification indicative of a switch from the first platform to a second platform to enable the user equipment to access the second platform after the switch.

The network node 800 may include a network interface 802, a processor 820, and a memory 804, in accordance with some example embodiments. The network interface 802 may include wired and/or wireless transceivers to enable access other nodes including base stations, other network nodes, the Internet, other networks, and/or other nodes. The memory 804 may comprise volatile and/or non-volatile memory including program code, which when executed by at least one processor 820 provides, among other things, the processes disclosed herein with respect to the HAPS.

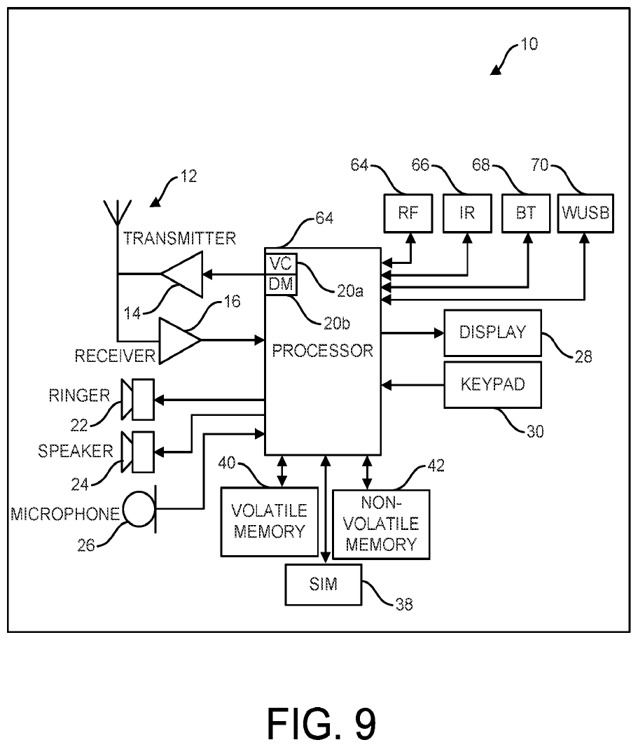

FIG. 9 illustrates a block diagram of an apparatus 10, in accordance with some example embodiments.

The apparatus 10 may represent a user equipment, such as the user equipment 205 and/or the like. In some embodiments, the apparatus may be configured to receive a notification indicative of a switch from a first platform to a second platform; calculate a timing advance for use with the second platform; and/or access the second platform after the switch to the second platform, the accessing based on at least the calculated timing advance.

The apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 9 as a single processor, in some example embodiments the processor 20 may comprise a plurality of processors or processing cores.

The apparatus 10 may be capable of operating with one or more air interface standards, communication protocols, modulation types, access types, and/or the like. Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced, 5G, and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 9, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations disclosed herein.

The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10. In the example embodiment, the processor 20 may be configured using computer code stored at memory 40 and/or 42 to the provide operations disclosed herein with respect to the UE.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable storage medium” may be any non-transitory media that can contain, store, communicate, propagate or transport the instructions for use by or in connection with an instruction execution system, apparatus, or device, such as a computer or data processor circuitry; computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein may be enhanced HAPS switching.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

1-58. (canceled)

59. A method comprising:
receiving, by a user equipment, a notification indicative of a switch from a first platform to a second platform;
calculating, by the user equipment, a timing advance for use with the second platform; and
accessing, by the user equipment, the second platform after the switch to the second platform, the accessing based on at least the calculated timing advance.

60. An apparatus comprising:
at least one processor; and
at least one memory including computer program code, the at least one memory and the computer program code configured to, with the at least one processor, cause the apparatus to at least:
receive a notification indicative of a switch from a first platform to a second platform;
calculate, a timing advance for use with the second platform; and
access the second platform after the switch to the second platform, the access based on at least the calculated timing advance.

61. The apparatus of claim 60, wherein the first platform comprises one or more of the following: an airborne platform, a spaceborne platform, and a high altitude platform station, and/or wherein the second platform comprises one or more of the following: an airborne platform, a spaceborne platform, and a high altitude platform station.

62. The apparatus of claim 60, wherein at least a portion of a first base station comprises, or is comprised in, the first platform, and/or wherein at least a portion of a second base station comprises, or is comprised in, the second platform.

63. The apparatus of claim 60, wherein a first base station is terrestrial and accesses, via a first repeater link, the first platform, and/or wherein a second base station is terrestrial and accesses, via a second repeater link, the second platform.

64. The apparatus of claim 60, wherein the apparatus is further caused to receive location information, wherein the location information includes a first location of the first platform and a second location of the second platform.

65. The apparatus of claim 60, wherein the apparatus is further caused to determine a location of the apparatus, in response to received notification and/or the received location information.

66. The apparatus of claim 65, wherein the location of the apparatus is determined based on at least geolocation circuitry at the apparatus.

67. The apparatus of claim 66, wherein the timing advanced is calculated based on at least the location of the apparatus and at least one of the first location of the first platform and the second location of the second platform.

68. The apparatus of claim 60, wherein the apparatus is further caused to receive a resource allocation for the apparatus accessing a physical random access control channel after the switch to the second platform, wherein the access of the second platform is further based on at least the received resource allocation.

69. The apparatus of claim 68, wherein after the switch, the second platform uses a different physical cell identifier than the first platform.

70. The apparatus of claim 60, wherein the apparatus is further caused to receive a switching time, wherein the access of the second platform is further based on at least the received switching time.

71. The apparatus of claim 70, wherein after the switch, the second platform uses a same physical cell identifier as the first platform, and wherein the switching time comprises a subframe number, and/or wherein the switching time is received from the first platform.

72. The apparatus of claim 60, wherein the apparatus is further caused to receive information about the second platform, wherein the received information includes the physical cell identifier, a synchronization signal block timing index, and/or a synchronization signal block measurement timing configuration time shift, wherein the timing advance calculation is further based on a synchronization signal block timing difference between the second platform and the first platform.

73. The apparatus of claim 60, wherein the apparatus is further caused to receive an indication of an addition or a deletion of an inter-platform link between the first platform and the second platform, wherein the timing advance calculation is further based on a change in delay associated with the addition or the deletion.

74. The apparatus of claim 60, wherein the apparatus comprises, or is comprised in, a user equipment.

75. An apparatus comprising:
at least one processor; and
at least one memory including computer program code, the at least one memory and the computer program code configured to, with the at least one processor, cause the apparatus to at least:
serve at least a user equipment; and
broadcast a notification to the user equipment, the notification indicative of a switch from the apparatus to a second platform to enable the user equipment to access the second platform after the switch.

76. The apparatus of claim 75, wherein the apparatus comprises one or more of the following: an airborne platform, a spaceborne platform, and a high altitude platform station, and/or wherein the second platform comprises one or more of the following: an airborne platform, a spaceborne platform, and a high altitude platform station.

77. The apparatus of claim 75, wherein at least a portion of a first base station comprises, or is comprised in, the apparatus, and/or wherein at least a portion of a second base station comprises, or is comprised in, the second platform.

78. The apparatus of claim 75, wherein the apparatus is further causes to send, to the user equipment, information about the second platform, wherein the information includes the physical cell identifier, a synchronization signal block timing index, and/or a synchronization signal block measurement timing configuration time shift, wherein the timing advance calculation is further based on a synchronization signal block timing difference between the second platform and the apparatus.
